(19) United States
(12) Patent Application Publication
(10) Pub. No.: US 2022/0253930 A1
(43) Pub. Date: Aug. 11, 2022

(54) CREDIT PROFILE GENERATION BASED ON BEHAVIOR TRAITS

(71) Applicant: Intuit Inc., Mountain View, CA (US)

(72) Inventors: Daniel Ben David, Kibbutz Harel (IL); Saikat Mukherjee, Fremont, CA (US); Nirmala Ranganathan, San Jose, CA (US); Kymm Kause, San Jose, CA (US); Yair Horesh, Kfar-Saba (IL)

(73) Assignee: Intuit Inc., Mountain View, CA (US)

(21) Appl. No.: 17/172,551

(22) Filed: Feb. 10, 2021

(51) Int. Cl. G06Q 40/02; G06F 16/2458; G06F 16/2457; G06F 16/28

(52) U.S. Cl. CPC G06Q 40/025; G06F 16/285; G06F 16/24573; G06F 16/2468

(57) ABSTRACT

Systems and methods for generating a credit profile based on user behavior traits are disclosed. A system may be configured to obtain a plurality of financial based interactions of a user, generate one or more behavior trait indicators based on the plurality of financial based interactions, and generate the credit profile of the user based on the one or more behavior trait indicators. A behavior trait indicator may include a self-control indicator regarding discretionary spending, an ostrich bias indicator regarding user interactions after negative news or events, or a procrastination indicator based on voluntary late payments to user accounts.

### TECHNICAL FIELD

This disclosure relates generally to machine learning based systems and methods for generating a credit profile based on behavior traits of a user.

### DESCRIPTION OF RELATED ART

A credit score is a tool to estimate a user's financial health. For example, a credit score provides feedback regarding a user's liabilities, including existing credit card accounts, credit card balances, and other liabilities incurred by the user. Financial institutions base many financial decisions on the user's credit score, such as approving a user for a new credit card account, approving the user for a home mortgage or loan, determining an interest rate for the loan, determining a insurance rates, and so on. The user may attempt to improve his or her credit score based on how the credit score is generated (such as by not opening additional credit card accounts and paying down credit card balances), which may improve the user's financial health.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for generating a credit profile based on a user's behavior traits. The example method includes obtaining a plurality of financial based interactions of a user, generating one or more behavior trait indicators based on the plurality of financial based interactions, and generating the credit profile of the user based on the one or more behavior trait indicators.

Another innovative aspect of the subject matter described in this disclosure can be implemented in a system for generating a credit profile based on a user's behavior traits. An example system includes one or more processors and a memory storing instructions that, when executed by the one or more processors, cause the system to perform operations. The operations include obtaining a plurality of financial based interactions of a user, generating one or more behavior trait indicators based on the plurality of financial based interactions, and generating the credit profile of the user based on the one or more behavior trait indicators.

The one or more behavior trait indicators can include a self-control indicator, an ostrich bias indicator, or a procrastination indicator. The self-control indicator may be associated with the user's discretionary spending habits during defined time periods. The ostrich bias indicator may be associated with the user's activity during a time after bad economic or societal news is released. The procrastination indicator may be associated with a user's payment of liabilities in light of the user's ability to do so.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example system for generating a credit profile based on a user's behavior traits, according to some implementations.

FIG. 2 shows an illustrative flow chart depicting an example operation for generating a credit profile, according to some implementations.

FIG. 3 shows an illustrative flow chart depicting an example operation for generating a self-control indicator, according to some implementations.

FIG. 4 shows an illustrative flow chart depicting an example operation for generating an ostrich bias indicator, according to some implementations.

Like numbers reference like elements throughout the drawings and specification.

### DETAILED DESCRIPTION

Implementations of the subject matter described in this disclosure may be used to generate a credit profile based on a user's behavior traits. A system uses machine learning tools to determine a user's behavior traits and generates the user's credit profile based on the behavior traits. As used herein, a behavior trait refers to a measurement or estimate of a user's proclivity to perform financial decisions in light of societal factors. The behavior trait may be associated with the user's individual preferences, habits, or decision making process, and a behavior trait indicator may indicate such preferences, habits, or decision making process. For example, a user's behavior trait indicator (such as a score) may include or indicate a measurement of a user's actions corresponding to days associated with heightened spending, corresponding to negative news, or corresponding to procrastination.

Typical credit profiles are generated exclusively based on a user's liabilities (such as number of credit card accounts or other credit accounts, amounts owed for each credit account, other debts, and other liabilities). For example, a Fair Isaac Corporation (FICO) score is an industry accepted credit score in the United States (US) based on debts, debt utilization, and other liabilities of a user. Opening of credit cards, loan interest rates, and other factors may be based on a user's FICO score. To attempt to enhance credit scores that are based on liabilities, a user's assets may be included into the equation for generating the credit score. For example, a user's income, amounts in savings accounts, liquidity levels, and long-term savings may be used to supplement a user's FICO score. A mortgage servicer may determine approval of a mortgage based on the user's credit score and assets.

A user may attempt to improve his or her credit score based on known factors affecting the credit score. For example, the user may pay down credit card debt, not use credit accounts to the maximum limit, not close older credit accounts, and not open new credit accounts for a couple of months in an attempt to raise the user's credit score. If the user is to apply for a new mortgage, the user may delay large purchases and ensure a savings account includes a steady amount until after the mortgage is obtained.

As can be seen in the above examples, credit scores are based on liabilities and, optionally, assets. Since the credit score is based only on liabilities and assets, a user's actions to improve his or her credit score can be short term remedies without affecting the user's long term habits to improve the user's financial health. For example, a user delaying purchases will still make such purchases after obtaining a mortgage, and a user paying down debt may again amass such debt after obtaining a new credit account. In addition, institutions making financial decisions on a user's credit worthiness (such as whether to approve a new credit account or mortgage) does not take into account the user's behavior long term that may affect the user's credit worthiness.

Various implementations of the subject matter disclosed herein provide one or more technical solutions to the technical problem of generating credit profiles. In some implementations, a system is configured to generate a credit profile based on a user's behavior traits. For example, the credit profile may be based on an indication of the user's self-control for discretionary purchases, an indication of a user to avoid negative news, or an indication of a user to procrastinate regarding financial decisions. The system may use one or more machine learning tools to determine the behavior trait indicators used in generating the credit profile. Unlike conventional systems for generating a credit score based on a user's liabilities (and, optionally, a user's assets), basing a credit profile on a user's behavior traits allows for more informed and beneficial financial decisions to be made. For example, with a user's credit profile based on the user's behavior traits, the user attempting to improve his or her credit profile may cause changes in the user's long-term behavior (such as improving the user's self-control over discretionary purchases, improving the user's handling of negative news, or improving the user's procrastination regarding financial decisions). In addition, a financial institution can make more informed decisions in providing credit or terms of the credit using a credit profile based on the user's behavior traits.

Various aspects of the present disclosure provide a unique computing solution to a unique computing problem that did not exist prior to the computer-implemented generation of credit profiles or scores of a plurality of users. As such, implementations of the subject matter disclosed herein are not an abstract idea such as organizing human activity or a mental process that can be performed in the human mind. Training a system (such as one or more machine learning models) and using the system to generate credit profiles based on user behavior traits cannot be performed in the human mind, much less using pen and paper.

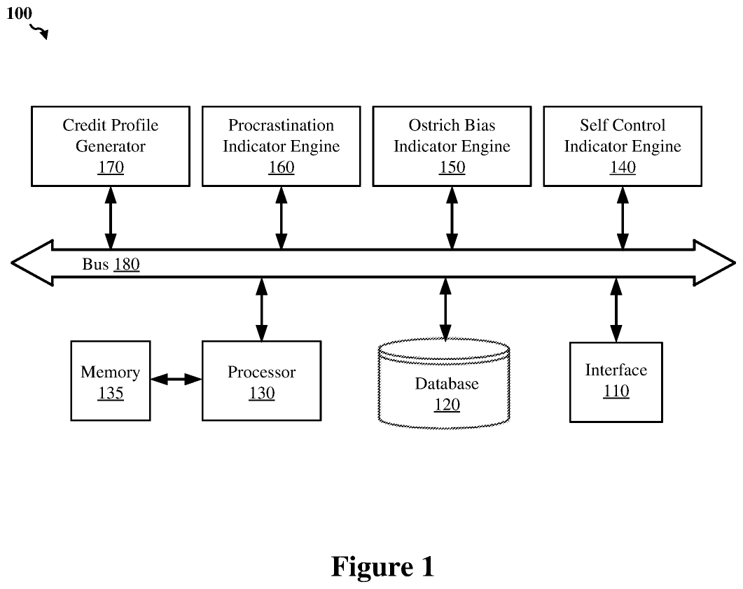

FIG. 1 shows an example system 100 for generating one or more credit profiles, according to some implementations. The system 100 includes an interface 110, a database 120, a processor 130, a memory 135 coupled to the processor 130, a self-control indicator engine 140, an ostrich bias indicator engine 150, a procrastination indicator engine 160, and a credit profile generator 170. In some implementations, the various components of the system 100 may be interconnected by at least a data bus 180, as depicted in the example of FIG. 1. In other implementations, the various components of the system 100 may be interconnected using other suitable signal routing resources.

The interface 110 may be one or more input/output (110) interfaces to receive financial based interactions of one or more users and provide one or more credit profiles generated by the system 100. An example interface may include a wired interface or wireless interface to the internet or other means to communicably couple with user devices or financial institutions. For example, the interface 110 may include an interface with an ethernet cable to a modem, which is used to communicate with an internet service provider (ISP) directing traffic to and from user devices or financial institutions (such as banks, investment firms, or mortgage companies that have accounts for the user). As used herein, communicating with a “user” or receiving/providing traffic from/to a “user” may refer to communicating with the user's device (such as a smartphone, tablet, personal computer, or other suitable electronic device) or a financial institution acting on the user's behalf. The interface 110 may also include a display, a speaker, a mouse, a keyboard, or other suitable input or output elements that allow interfacing with the system 100 by a local user or moderator.

The system 100 may be configured to execute a financial management application. For example, a user may use a financial aggregator application that provides a central interface for all user accounts and information that the user provides to the application. The application may show the current status of savings and checking accounts, credit card accounts, mortgages, car loans, student loans, retirement accounts, or investments as obtained from the financial institutions servicing such accounts. The current status of accounts may include individual transactions (such as date and amount of each credit card transaction, date and amount a bill is paid for an account, daily change in value of investments, and so on). In some implementations, the system 100 also stores the application (such as in the database 120 or the memory 135) and execute the application (such as by the processor 130) to provide the user a convenient interface for the user accounts. In this manner, user information from the application may be used in generating a credit profile for the user. In some other implementations, the application is executed by a local user device communicably coupled to the system 100, and the system 100 obtains information from the local user device executing the application to generate a credit profile for the user.

The database 120 may store the financial based interactions for one or more users, or any indicators or other information generated or used by the components 140-170. The database 120 may also store the financial management application. In some implementations, the database 120 may include a relational database capable of presenting the information as data sets in tabular form and capable of manipulating the data sets using relational operators. The database 120 may use Structured Query Language (SQL) for querying and maintaining the database 120.

The processor 130 may include one or more suitable processors capable of executing scripts or instructions of one or more software programs stored in system 100 (such as within the memory 135). The processor 130 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may include a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the processor 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The credit profile generator 170 may generate a credit profile for one or more users based on one or more behavior trait indicators for a user. In some implementations, the system 100 is used by a credit bureau, and the credit profile generator 170 generates credit profiles for a large number of people (such as thousands or millions of people). In this manner, the system 100 obtains (via the interface 110) financial based interactions for the large number of people, determines one or more behavior trait indicators for each person, and generates a credit profile for each person based on the one or more behavior trait indicators. In some other implementations, the system 100 may be used by a user to generate the user's personal credit score. In some implementations, the credit profile generator 170 generates a user's credit profile based on one or more of a self-control indicator, an ostrich bias indicator, or a procrastination indicator for a user.

A credit profile may be any suitable format to indicate a credit worthiness of a user. In some implementations, the credit profile may be a single score. For example, one or more credit scores based on user behavior traits may be determined, and the one or more credit scores may be combined to generate a single score. In some other implementations, the credit profile may be a vector of scores. For example, the credit profile may include a first score based on a self-control indicator, a second score based on an ostrich bias indicator, and a third score based on a procrastination indicator. In addition to user behavior traits, the credit profile may be based on liabilities of the user or assets of the user. In some implementations, the credit profile may be a compilation of a FICO score 8 or 9 and the one or more credit scores based on user behavior traits. The scores/profiles may be combined into a single score, may be presented as the FICO score and a supplemental credit profile, or may exist as any other suitable combination scores or implementation of a credit profile.

The credit profile generator 170 may be implemented in software, hardware, or a combination thereof. In some implementations, the credit profile generator 170 may be embodied in instructions that, when executed by the processor 130, cause the system 100 to perform operations associated with the credit profile generator 170. The instructions may be stored in memory 135, the database 120, or another suitable memory.

The self-control indicator engine 140 may generate a self-control indicator for one or more users. A self-control indicator refers to an indicator regarding a user's self-control regarding spending (such as for discretionary purchases). A user's self-control regarding spending may be used to predict potential future bankruptcy, future credit card debt, or other financial outcomes (such as forbearance, debt forgiveness, and so on). For example, a self-control indicator may include a score indicating a prediction as to potential future bankruptcy or future credit card debt of the user based on a plurality of self-control metrics determined from the financial based interactions.

The self-control indicator engine 140 may be implemented in software, hardware, or a combination thereof. In some implementations, the self-control indicator engine 140 may be embodied in instructions that, when executed by the processor 130, cause the system 100 to perform operations associated with the self-control indicator engine 140. The instructions may be stored in memory 135, the database 120, or another suitable memory.

The ostrich bias indicator engine 150 may generate an ostrich bias indicator for one or more users. An ostrich bias indicator refers to an indicator regarding a user's handling of negative news (such as drops in financial instruments or markets, drops in the user's asset values, negative public news, or other events that may affect a user's financial discipline or motivation). For example, an ostrich bias indicator may be based on a user's login pattern to the financial management application around the time of asset value drops or a user's interaction with the application during such times.

The ostrich bias indicator engine 150 may be implemented in software, hardware, or a combination thereof. In some implementations, the ostrich bias indicator engine 150 may be embodied in instructions that, when executed by the processor 130, cause the system 100 to perform operations associated with the ostrich bias indicator engine 150. The instructions may be stored in memory 135, the database 120, or another suitable memory.

The procrastination indicator engine 160 may generate a procrastination indicator for one or more users. A procrastination indicator refers to an indicator regarding a user's procrastination in handling financial matters (such as paying bills or otherwise handling financial matters needing attention). For example, a procrastination indicator may be based on a user's ability to pay a debt in view of the user's debt and income and the user's voluntary procrastination in paying such debt based on the user's ability to pay.

The procrastination indicator engine 160 may be implemented in software, hardware, or a combination thereof. In some implementations, the procrastination indicator engine 160 may be embodied in instructions that, when executed by the processor 130, cause the system 100 to perform operations associated with the procrastination indicator engine 160. The instructions may be stored in memory 135, the database 120, or another suitable memory.

As noted above, the credit profile generator 170 may generate a credit profile from the indicators generated by the engines 140-160. Example implementations of generating the indicators and generating the credit profile are provided in the examples below.

The particular architecture of the system 100 shown in FIG. 1 is but one example of a variety of different architectures within which aspects of the present disclosure may be implemented. For example, in other implementations, components of the system 100 may be distributed across multiple devices, may be included in fewer components, and so on. While the below examples are described with reference to system 100, any suitable system may be used to perform the operations described herein.

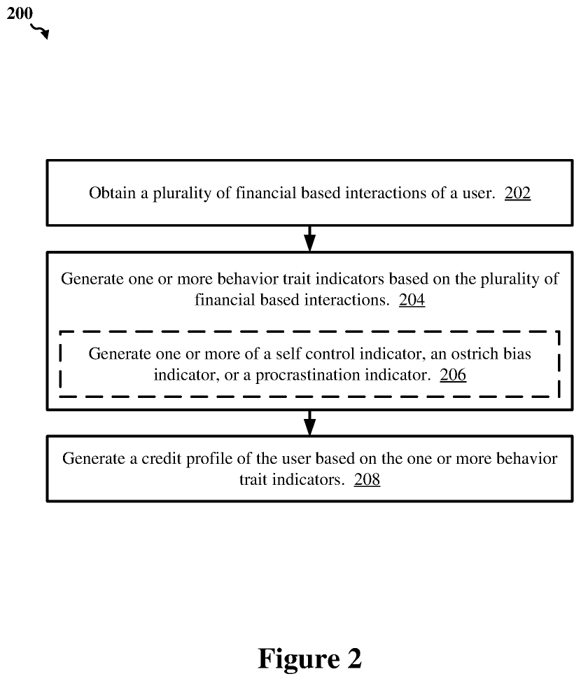

FIG. 2 shows an illustrative flow chart depicting an example operation 200 for generating a credit profile. At 202, the system 100 obtains a plurality of financial based interactions of a user. For example, the system 100 may execute a financial management application/tool (such as described above). In executing the application, the system 100 obtains a plurality of financial transactions and information for a plurality of user accounts. In some implementations, the system 100 requests for and obtains (via the interface 110) a current account balance, due date, amount due, transactions recorded, asset value, and change in value from one or more financial institutions (such as a bank, credit union, mortgage servicer, student loan servicer, investment firm, and so on) for one or more user accounts. The user may link the accounts wished to be included in the tool (such as during an initial setup of the tool including linking user accounts based on user credentials with the financial institution, which are volunteered by the user to the tool). The system 100 may obtain such information periodically, during startup of the tool, or upon request from the user for the tool to update the information.

The financial management tool provides a single user interface for the user to review each of the accounts. For example, the tool may indicate current asset values in the investment accounts (such as mutual fund holdings, stocks, bonds, real estate, or other assets owned by the user) and changes to the asset values. The tool may also indicate other financial instrument values (such as the Dow Jones Industrial Average (DJIA), Standard & Poor's 500 (S&P 500) index, NASDAQ index, Nikkei index, DAX index, STOXX 600 average, or values of assets indicated as of interest by the user). In some implementations, the financial management tool provides other functions to the user. For example, the tool may include a financial goal section to indicate a user's progress towards any goals indicated by the user to the tool (such as paying down credit card debt, saving money towards a down payment to a house, reaching a milestone in a retirement account, and so on). Other functions may also include budget tools, charts and graphical interfaces showing trends in one or more accounts, reminders of payments due, push notifications regarding the user's goals, indications of the user's FICO score, and literature and other educational resources. In some implementations, in addition or alternative to providing the FICO score, the tool can provide the credit profile generated based on the behavior trait indicators. The tool can also provide suggestions to improving such credit profile (such as to improve the self-control indicator, the ostrich bias indicator, or the procrastination indicator). As noted above, the credit profile may include a score combining scores for the different indicators (such as a simple average, weighted average, and so on), may include a vector of scores for the different indicators, or may be in any other suitable format.

The financial based interactions obtained by the system 100 also may include user interaction metrics with the financial management tool. For example, the system 100 may generate a record of the user's logins to the tool, which portions of the tool are accessed by the user each time, amount of time the user interacts with the tool, or other measurements of the user interacting with the financial management tool. In this manner, in addition to account and transaction information, the user behavior trait indicators may be based on user interactions with the tool.

Referring back to step 202 in FIG. 2, the system 100 may obtain the financial based interactions from one or more financial institutions and based on the user's interaction with the tool. At 204, the system 100 generates one or more behavior trait indicators based on the plurality of financial based interactions. In some implementations, the system 100 may generate one or more of a self-control indicator (by the engine 140), an ostrich bias indicator (by the engine 150), or a procrastination indicator (by the engine 160) (206). For example, each of the indicators may be a score determined by each of the engines 140-160. At 208, the system 100 generates a credit profile of the user based on the one or more behavior trait indicators. For example, the system 100 generates a single score by combining the scores generated by the engines 140-160. In another example, the system 100 generates a vector of scores including the scores generated by the engines 140-160. The credit profile may include additional information, such as highlights of specific transactions or user behavior traits to indicate to the user the reasoning behind the credit profile. The generated credit profile may be stored in the database 120, the memory 135, or another suitable system memory. While not shown, the system 100 may provide the credit profile to the user (such as via a graphic user interface (GUI) of the financial management tool) or may provide the credit profile to a credit bureau or credit servicer upon request of the user. If provided to the user, the financial management tool can provide assistance in rehabilitating some user habits to improve the user's financial health (such as ways to cause behavioral changes to increase self-control, reduce the user's avoidance of negative news, or reduce procrastination).

Example implementations of generating the one or more indicators by the engines 140-160 are provided below.

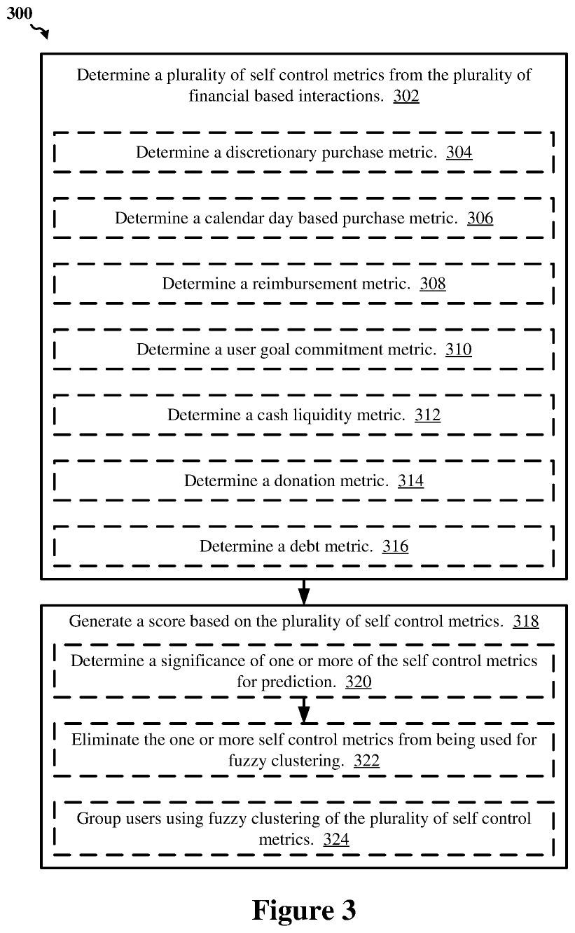

FIG. 3 shows an illustrative flow chart depicting an example operation 300 for generating a self-control indicator. Operation 300 being performed by the system 100 may refer to the self-control indicator engine 140 performing one or more steps of the example operation. The self-control indicator may include a score indicating a prediction as to potential future bankruptcy or future credit card debt, and the indicator may be based on a plurality of self-control metrics. At 302, the system 100 determines a plurality of self-control metrics from the plurality of financial based interactions. The financial based interactions are the information obtained in step 202 in FIG. 2, and the self-control indicator engine 140 determines the self-control metrics from the obtained information.

In some implementations of determining the self-control metrics, the system 100 determines a discretionary purchase metric (304). People with lower self-control on discretionary purchases may tend to spend money close to when the money is received. The discretionary purchase metric is a measurement of the timing of purchases and the users spend with reference to when the user receives money. For example, the system 100 determines the amount of money spent (excluding periodic payments (such as not including rent payments, insurance payments, mortgage payments, and so on)) within a threshold number of days of a payday (such as 3 or 5 days after payday). In some implementations, the system 100 determines the payday as the day when a paycheck is deposited into the user's checking or savings account, and the system 100 filters credit card and checking purchases to transactions within a threshold number of days after the payday (such as 3 days or 5 days). The purchases may also be filtered based on the establishment of purchase. For example, transactions from home goods, electronics, and other such stores will be included in the filtered transactions, while transactions with a homeowner's association, mortgage servicer, or loan servicer may be excluded from the filtered transactions. In some implementations, the system 100 categorizes the establishments for the self-control metric based on previous indications by the user (or other users), based on prior knowledge, or based on an indication from the establishment/merchant of the type of establishment. The discretionary purchase metric may include a percentage of the paycheck spent on such purchases within the threshold number of days. A percentage may be determined over a plurality of paychecks, and the percentages may be averaged to generate a total percentage. In some other implementations, the metric may be an aggregate amount of money spent over one or more paychecks. While the examples above are regarding a paycheck, any form of income may be used to determine the discretionary purchase metric, such as fixed income payments, dividends, cash or personal check deposits, and so on.

In some implementations of determining the self-control metrics, the system 100 determines a calendar day based purchase metric (306). People with lower self-control on discretionary purchases may tend to spend more money on calendar days associated with merchant sales. Days associated with merchant sales include New Year's Day (January 1), President's Day in the US, Memorial Day in the US, US Independence Day, Amazon's Prime Day or Prime Week, Black Friday in the US, Cyber Monday in the US, Boxing Day in Great Britain, the week leading up to Lunar New Year in some countries, and so on. The calendar days may be defined in the system 100 for a user based on the user's geographic location. The calendar day based purchase metric is a measurement of the users spend on such defined calendar days. Similar to the discretionary purchase metric, the payments may be filtered based on the establishment and being non-periodic (in addition to being filtered to the defined calendar days). The metric may be a percentage of income, an aggregate amount spent, or any other suitable indicator of purchases incurred during the defined calendar days.

In some implementations of determining the self-control metrics, the system 100 determines a reimbursement metric (308). People with lower self-control on discretionary purchases may have buyer's remorse or otherwise have a higher propensity to return purchases to the merchant. The reimbursement metric is a measurement of user returns of previous purchases. In some implementations, the system 100 identifies returns from chargebacks to credit cards. The system 100 may further identify a return based on the amount charged back and/or the merchant name matching a previous transaction for the merchant. The system 100 may generate the metric as a percentage of purchase amounts (such as total amount of returned items divided by total amount of discretionary purchases). The system 100 may filter purchases to discretionary purchases based on establishment names (which may be indicated by the user or other users as discretionary) or being non-periodic purchases. Alternatively or additionally, the system 100 may generate the metric as a total amount of returned items over a time period (such as per month).

In some implementations of determining the self-control metrics, the system 100 determines a user goal commitment metric (310). People with lower self-control on discretionary purchases may have more difficulties in achieving user goals. The user goal commitment metric is a measurement of the user's progress in achieving such goals. As noted above, the financial management tool may obtain user defined goals from the user (such as to pay off a specific credit card debt or save a specific amount of money in savings as a down payment for a house). The system 100 may periodically measure the user's progress. For example, the system 100 may measure a credit card balance every month or may measure an average savings account balance every month. The system 100 may determine a trend (such as a percentage or amount decrease in the credit card balance, a percentage or amount increase in the savings account balance, and so on) and determine the metric based on the trend. The metric may indicate how quickly the user is to achieve his or her goals. The metric may also be based on how many goals the user has achieved, how many goals the user has yet failed to achieve, or the age of yet unachieved goals. Such measurements may be combined in any suitable manner to generate the metric (such as through a weighted average, other heuristic means, or machine learning based clustering for users with similar traits to determine a common metric for the users).

In one example, the metric measures achieved goals vs. unachieved goals (such as +1 for achieved goals and −1 for unachieved goals greater than a threshold age). The user goal commitment metric may also be based on commitment devices to ensure support for others (such as life insurance, disability insurance, or annuities). For example, the score of achieved goals vs. unachieved goals may be adjusted based on the existence of such commitment devices (for example, +1 for life insurance, +1 for life insurance above a threshold amount, and so on). The user commitment metric may also be based on reaching certain debt milestones. For example, the above score may be adjusted by −1 if a credit card average balance increases to a threshold amount.

In some implementations of determining the self-control metrics, the system 100 determines a cash liquidity metric (312). People with lower self-control on discretionary purchases may have less cash reserves or liquidity for an emergency. The cash liquidity metric is a measurement of the user's liquid assets, including stocks, bonds, mutual funds, and savings account balances. The system 100 may determine the cash liquidity metric to include an indication of a value of liquid assets, a percentage of liquid assets to debts, or any other suitable measurement based on the financial account information obtained for the financial management application.

In some implementations of determining the self-control metrics, the system 100 determines a donation metric (314). People with lower self-control on discretionary purchases may be less consistent in donations to specific charities. For example, donations to US 501(c)(3) charities (such as religious institutions) may be more consistent for people with greater self-control. In some implementations, the system 100 determines the metric as a measurement of the number of consecutive months, the number of months within a year, or another metric as to how periodically and consistently the user donates to a specific charity.

In some implementations of determining the self-control metrics, the system 100 determines a debt metric (316). People with lower self-control on discretionary purchases may have higher debt levels and/or more debt accounts (such as automobile loans and credit card accounts). In some implementations, the system 100 determines a measurement of debt minus income and savings. For example, the system 100 adds the amounts of all outstanding debt (such as auto loans, credit card debt, student loans, and so on). In some implementations, the system 100 may filter some types of debt from being included in the sum. For example, some types of debt may be predefined as not to be included, which may be debt conventionally considered higher quality (such as student loans and home mortgages).

Having summed the total debt, the system 100 may subtract total savings. Savings may include investment accounts, post-tax retirement accounts, savings accounts, or other liquid savings that are accessible to the user. The system 100 may also determine an income based amount to subtract from the total debt minus savings. For example, the system 100 may determine a monthly discretionary income amount (such as monthly income minus a living wage defined by a government or other institution, or monthly income minus recurring expenses identified in the financial management application), and the system 100 multiplies the monthly discretionary income by a defined number of months (such as 12 or 24 months) to obtain the total amount to be subtracted from the total debt minus savings. In some other implementations of the debt metric, the system 100 may determine the total number of debt accounts vs savings accounts (such as counting debt accounts having a debt above a threshold and savings/investment accounts having amounts above another threshold). In some other implementations, the system 100 may determine the debt metric to be a total amount of user debt from the debt accounts.

After determining the plurality of self-control metrics in step 302, the system 100 generates a score based on the plurality of self-control metrics (318). Self-control metrics are determined for a plurality of users, and the system 100 may group the current user with other similar users based on common self-control metrics. In some implementations, the system 100 groups users using fuzzy clustering of the plurality of self-control metrics (324). For example, each self-control metric is represented as a dimension for fuzzy clustering, and the users are grouped based on distances and distribution between the users across the dimensions. The system 100 may determine a common score for each group of users, with the score indicating a level of financial self-control for purchases. Fuzzy clustering is a machine learning model implemented by the system 100 for performing operations of the self-control indicator engine 140. For example, in implementing the fuzzy clustering model, the system 100 assigns each user to one or more groups of users based on the total distance (across all dimensions) between the user's metrics and the group of users' metrics in each group. Since the clustering model is fuzzy, a user may be assigned to more than one group. For example, the system 100 determines a location of the user in a coordinate system based on the user's self-control metrics (with each metric being along a unique axis). The system 100 may also determine a centroid of each group based on all of the self-control metrics in the group. The system 100 then determines a distance between the user and each group based on the centroid. If the distance between the user and a first group and the distance between the user and a second group is approximately the same, the system 100 may assign the user to the first group and to the second group. Since the user may be assigned to multiple groups, the system 100 may determine a membership grade for the user for each assigned group. For example, the membership grade may indicate a distance between the group's centroid and the user's location in the coordinate system. The membership grade may also indicate a variation from the distribution of users in the group (such as whether the user is more of an outlier based on how densely distributed the other users are in the group). For example, the system 100 may determine a distribution having a mean and variance from the other users' metrics in the group, and the system 100 may identify a location of the user along the distribution (with the membership grade assigned based on how many standard deviations the user is from the mean). As users are added to groups, the centroids' locations change. In some implementations, a centroid location is also based on the users' membership grades. For example, the system 100 may adjust the centroid location by a defined percentage associated with a membership grade to prevent outliers from distorting the centroid.

During fuzzy clustering, the system 100 groups a plurality of users into different clusters. In this manner, the system 100 may recursively group and ungroup users and adjust the number of clusters to attempt to optimize the clusters. The system 100 may also adjust a fuzzifier indicating how hard the threshold is between groups (a cluster fuzziness that allows users to be assigned to multiple groups). For example, a fuzzifier may indicate a number of standard deviations a user is allowed to be from a centroid of a group based on the group's distribution in order to be assigned to the group. The fuzzifier may also be used in determining a membership grade. In some implementations, the number of clusters may be defined (such as based on a number of self-control indicator/score tiers). For example, the self-control indicator may indicate a high/medium/low level of self-control, and the number of groups may be defined to be three. However, any resolution for measuring self-control for the indicator may be used.

Any suitable fuzzy clustering model may be used. For example, the system 100 may implement a fuzzy c-means (FCM) clustering model. In another example, a fuzzy clustering by local approximation of memberships (FLAME) model may be implemented. In some other implementations, the system 100 may use a hard clustering model.

As noted above, once the users are clustered, the system 100 assigns a score to each of the clusters that predicts potential future bankruptcy or future credit card debt of a user in the cluster. One self-control metric may be more significant towards predicting future bankruptcy or credit card debt than another self-control metric. The system 100 may filter which self-control metrics are to be used for fuzzy clustering of the users in step 324 based on the metrics' significance in predicting bankruptcy or credit card debt. For example, the system 100 determines a significance of one or more of the self-control metrics for the prediction (320), and the system 100 may eliminate the one or more self-control metrics from being used for fuzzy clustering (322).

In some implementations, the system 100 performs stepwise regression to determine which self-control metrics are to be used for fuzzy clustering. Stepwise regression may be a machine learning model implemented by the system 100 to determine which metrics are to be included or excluded for generating the score using fuzzy clustering. Example implementations of the stepwise regression model include forward selection (to determine which metrics to include), backward elimination (to determine which metrics to exclude), and bidirectional elimination (which is a combination of forward selection and backward elimination).

Over time, the system 100 may obtain information regarding users' bankruptcies and credit card debt (such as from the financial management application or from one or more credit bureaus). Previously determined metrics for the users and the bankruptcy and credit card debt information may be used as training data in determining the significance of each metric towards a score. For example, indicating a bankruptcy or revolving credit card debt from 0 (not occurring) to 1 (occurring) for a user, the score is a value between 0 and 1. The system 100 may cluster the users into two groups using fuzzy clustering (low or high risk associated with a score of 0 or 1, respectively), and the system 100 determines a score for a user based on assignment and membership grades of the user. The system 100 may then determine an error between the score/prediction and the obtained information regarding bankruptcy and credit card debt.

The system 100 iteratively determines the scores for the users using a subset of metrics, measures the errors for the scores, adjusts the subset of metrics (adding and/or removing metrics), and repeats determining the scores until an optimal set of metrics are determined that minimizes the errors (such as minimizing the number of users falsely classified as low risk or high risk). In some implementations, the system 100 implementing stepwise regression determines a correlation between each self-control metric and a prediction accuracy. The system 100 may eliminate one or more self-control metrics from use in fuzzy clustering based on the metric's correlation being less than a correlation threshold. As more information regarding bankruptcies and credit card debt is obtained over time, the system 100 may update the correlations or the correlation threshold to improve the predictions. For example, the system 100 may periodically determine the scores' error. If the error becomes greater than a threshold (such as a percentage of users greater than a threshold being misclassified as low risk or high risk), the system 100 may update the correlations or the correlation threshold (thus adjusting the subset of metrics to be used for fuzzy clustering) to improve the predictions. The stepwise regression model may also be used in determining cross-correlations between metrics, which may also be used in filtering the metrics for fuzzy clustering.

The self-control indicator, which may be a predictive score of bankruptcy or credit card debt as described above, may be any suitable value (such as a binary indication of low/high risk, a trinary indication of low/medium/high risk, or a value along a number scale). The self-control indicator, the metrics, the correlations, the thresholds, the machine learning models, or any other data regarding the one or more machine learning models to be output or used by the self-control indicator engine 140 may be stored in the database 120 or the memory 135.

In addition or alternative to the system 100 generating a self-control indicator, the system 100 may generate an ostrich bias indicator. An ostrich bias indicator indicates a user's likelihood to ignore or avoid a negative news event or to perform detrimental actions in light of the negative news event. Avoiding negative news may affect a user's financial health. For example, users who tend to avoid negative news are more likely to pay more non-sufficient funds (NSF) fees than other users. As noted above, a negative news event may refer to a user's asset value decreasing by a threshold amount or a financial instrument value decreasing by a threshold amount. While the below examples of a negative news event are with reference to a decrease in user asset values and financial instrument values, any suitable metric of a negative news event may be used. For example, a negative news event may also refer to a number of negative social news metrics being greater than a threshold (such as negative public headlines in tracked newspapers or social media being greater than a threshold for a day or a sentiment of headlines being less than a threshold for a day).

The ostrich bias indicator may be determined based on information regarding a user's interaction with the financial management tool. In some implementations, the financial based interactions of the user include user interaction metrics with the financial management tool. For example, the system 100 may determine a login pattern by the user to the financial tool (such as a record of how many times, how many days, or other frequency of user logins to the tool). Other user interaction metrics may include a pattern of the user accessing specific portions of the tool (such as pages showing the decreased asset or financial instrument), a pattern of the amount of time the user interacts with the tool, or a pattern of the interactions performed by the user each time the user logs in to the tool. Certain variations in the metrics may indicate a tendency of the user to avoid negative events that may affect the user's sentiment. For example, a reduction in login attempts directly around a negative event (such as within 5 days of the event) may indicate a user tendency to avoid negative news.

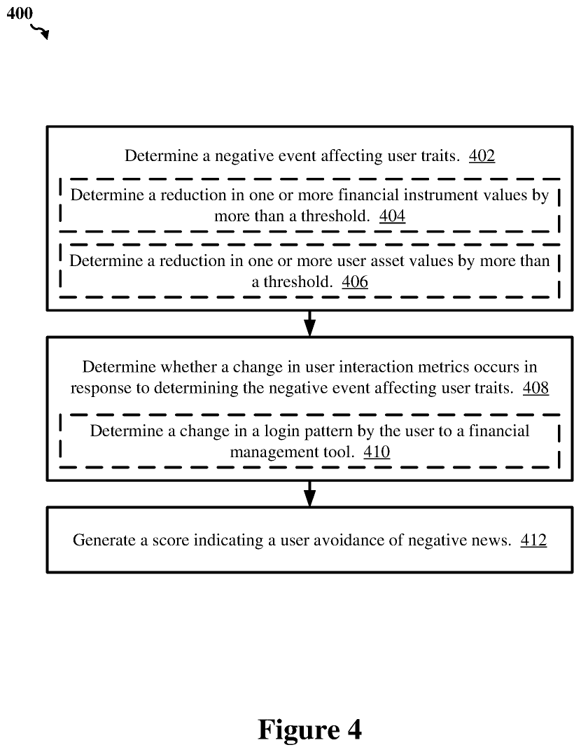

FIG. 4 shows an illustrative flow chart depicting an example operation 400 for generating an ostrich bias indicator. Operation 400 being performed by the system 100 may refer to the ostrich bias indicator engine 150 performing one or more steps of the example operation. At 402, the system 100 determines a negative event affecting user sentiment. Changes in a user behavior may be based on changes in the macroeconomic environment. In some implementations, the system 100 determines a reduction in one or more financial instrument values by more than a threshold (404). For example, the system 100 may determine when a market index (such as the S&P 500 or other public indexes) is down more than 3 percent from a most recent peak. Determining a peak may be based on a smoothing average, stochastic curves, or any other means to determine a local maximum of the index. The system 100 may identify the day that the market index is less than 97 percent (or another suitable threshold) of the determined local maximum as a negative macroeconomic event. In another example, the system 100 determines a daily reduction in value of the S&P 500 to be greater than 3 percent.

Changes in user behavior may also be based on personal asset changes. In some implementations, the system 100 determines a reduction in one or more user asset values by more than a threshold (406). Example user assets include a stock portfolio, a retirement account, a mutual fund, or other investment of the user. The system 100 may determine when the user asset is down more than three percent (or another suitable threshold) from a most recent peak or for the day (such as described above with reference to step 404).

Other example user assets may include a checking account or a savings account. The system 100 may track changes in a total daily balance across all bank accounts for a user. The system 100 identifies an increased reduction in the total daily balance over one or more days as a negative event. In some implementations, the system 100 determines a reduction in the total daily balance over one or more days to be greater than the average reduction in the total daily balance for the same number of days (which may be referred to as a negative net balance out). The average reduction may be the average reduction over the same days across a plurality of calendar months (such as at the end of months when rent, mortgage, or other loan payments are due). The negative net balance out may be determined for each day (a negative daily net balance out). While the examples are regarding a negative daily net balance out, the one or more days may be any defined number of days (such as being measured over a week) and the threshold reduction in the daily balance may be any suitable threshold greater than zero.

In another example of a negative personal event, the system 100 may determine a day of a money-out transaction greater than a threshold amount to be a negative personal event. In some implementations, the system 100 determines that the transaction is discretionary spending (such as not being reoccurring (such as rent or loan payments), from specific merchants, or other indications that the spending is discretionary from the financial management tool). Such a transaction may be referred to as a money-out transaction.

At 408, the system 100 determines whether a change in user interaction metrics occurs in response to determining the negative event affecting user sentiment. In some implementations, the system 100 may determine a change in a login pattern by the user to the financial management tool around the time of the negative event (410).

As noted above, the system 100 may track daily login attempts to the financial management tool. For macroeconomic events, five days (or another suitable number of days) after each determined negative event are determined to be a first group of days associated with negative events. The other days are determined to be a second group of days not associated with negative events. The system 100 determines a login pattern for the second group of days as a baseline. For example, the system 100 may determine the proportion of the number of days from the second group that the user logs into the financial management tool to the total number of days in the second group. The system 100 may also determine a login pattern for the first group of days (such as the proportion of the number of days from the first group that the user logs into the financial management tool to the total number of days in the first group). The system 100 may then determine a difference in the proportions in determining a change in the user interaction metrics. In another example, the system 100 may determine a difference of logins for a specific user in proportion to the average difference of logins across a corpus of users. In some implementations, the system 100 excludes users who have not linked at least one investment account in the financial management tool. In addition or to the alternative, the system 100 may exclude users who have not logged in a threshold number of times prior to the negative events (such as less than two logins during the 8 weeks prior to a negative event).

For personal events, the system 100 determines a metric of logins associated with negative events. The system 100 tracks the user logins to the financial management tool. In some implementations, the system 100 determines which logins are associated with a negative personal event. For example, a login is associated with a money-out transaction if the login occurs in a range of days around the money-out transaction. An example range is a 5 day range (two days before, the day of, and two days after the money-out transaction or event), but any suitable range may be used. A login not within range for a negative personal event is not associated with the negative personal event. Conversely, if multiple negative personal events occur within a short amount of time (such as within 3 days of each other), a login may be associated with multiple negative personal events.

The system 100 may determine two ratios for negative personal events. One ratio is the number of money-out transactions associated with one or more logins divided by the total number of money-out transactions for a user. A lower ratio indicates that the user is less likely to log in to the financial management tool around the time of a money-out transaction or other negative event. Another ratio is the number of logins across the ranges of negative personal events divided by the total number of days across the ranges. Similarly, a lower ratio indicates that the user is less likely to log in to the financial management tool around the time of a money-out transaction or other negative event.

In this manner, the system 100 may determine a first login tracking metric for macroeconomic events and a second login tracking metric for personal events of a user in determining the change in login patterns (410). In some implementations, a smaller metric value indicates that a user is less likely to avoid negative news (which may be referred to as a smaller ostrich bias for the user). The metrics may be processed so that the metrics may be uniformly compared to one another.

At 412, the system 100 generates a score indicating a user avoidance of negative news (an ostrich bias). In some implementations, the system 100 combines the first login tracking metric and the second login tracking metric to generate a final score. For example, the system 100 may select the smallest metric between the two (indicating the smallest ostrich bias) as the score. In selecting the smallest metric, one of the metric for macroeconomic events or the metric for personal events may not unduly effect the other or skew the final metric if that metric is disproportionately larger than the other metric.

The system 100 may also generate a procrastination indicator. A procrastination indicator indicates a user's likelihood to procrastinate on financial actions or decisions. Procrastination may affect a user's financial health. For example, users who procrastinate in making debt payments pay more in interest and fees than other users. The procrastination indicator may be determined based on information regarding a user's assets or liquidity (indicating a user's ability to pay) and information regarding whether and when a user made payments to outstanding debts. The system 100 generating a procrastination indicator may refer to the procrastination indicator engine 160 performing one or more steps in generating the indicator.

In some implementations, the system 100 generates the procrastination indicator based on late payment fees paid by the user (or, in some implementations, billed to the user). Late payment fees may be identified in the financial management tool for one or more debt accounts (such as for credit cards, student loans, automobile loans, and so on). In some implementations, late payment fees may be based on only credit card accounts. To generate a procrastination indicator, the plurality of financial based interactions obtained by the system 100 includes information regarding credit card late fees paid by the user. In some implementations, the plurality of financial based interactions may also include information regarding credit card debt of the user, information regarding monthly income of the user, and information regarding savings of the user.

The system 100 may determine a metric of the total amount of late fees paid in a year, a total number of late fees paid in the year, or a combination of both as the procrastination indicator for a user. In some implementations, the metric may be a score based on a user's ability to pay credit card debt (and thus whether a user voluntarily procrastinates in paying credit card debt). For example, the system 100 generates an ability to pay metric based on user savings with reference to credit card debt and monthly income, and the system 100 generates a score indicating whether the user voluntarily procrastinates in paying credit card debt based on the ability to pay metric.

If the system 100 determines an ability to pay metric for each user, one or more users may be excluded for generating a procrastination indicator based on such metric (which may indicate a possibility that procrastination is not voluntary but instead may be as a result of an inability to pay). In some implementations, the system 100 determines an ability to pay metric as including an indication as to whether the user's savings is greater than one month of income. The ability to pay metric may also include an indication as to whether the user's savings (minus the one month of income) is greater than the monthly minimum payments due across credit card accounts. In this manner, the system 100 makes a binary decision as to whether the user's savings minus one month income minus minimum credit card payments for the month is greater than 0. In generating a score based on the ability to pay metric, if the decision is false (the difference is less than 0), the system 100 prevents generating a procrastination indicator for the user. If the decision is true (the difference is greater than 0), the system 100 determines a procrastination indicator for the user. As noted above, the procrastination indicator may be a score of the total amount of late fees paid in a year, a total number of late fees paid in the year, or a combination of both for a user. In some implementations, the procrastination indicator includes a classification of the user into one of three categories of rarely, sometimes, or frequently paying late fees. For example, if the score is the total number of late fees paid in a year, the system 100 may classify the user into one of the three categories based on a lower threshold number (such as one or two later payments) and an upper threshold number (such as 5 or 6 late payments) to differentiate the three categories. However, any suitable number of categories (such as two, four, or more) and any suitable threshold may be used.

After generating the one or more behavior trait indicators by engines 140-160, the system 100 (such as the credit profile generator 170) generates the credit score for the user based on the one or more behavior trait indicators. The credit profile generated using user behavior trait indicators may be in addition or alternative to a credit score based on liabilities of the user and/or assets of the user, or the credit profile may be generated also based on liabilities of the user or assets of the user (such as described above). A credit profile based on behavior trait indicators allows better prediction as to future spending habits of the user or credit worthiness of the user. The credit profile may also be used by the system 100 to more accurately notify users of issues with his or her spending habits, engagement, or financial awareness, provide financial education tools, or otherwise attempt to assist the user in improving his or her financial health (such as through better spending habits or better financial decisions to achieve financial goals to help achieve financial stability). For example, the system 100 may provide a credit profile to a user, and the credit profile may indicate money spent during sale days or close to paydays to notify the user of his or her self-control regarding spending, trends in the user interacting with the financial management tool to indicate the user's avoidance of negative news, and/or the number of times the user pays late fees to indicate a user's voluntary procrastination in paying credit card debt. In some implementations, the credit profile may be provided to the user in the financial management tool. In some other implementations, the credit profile may be provided in a separate communication to the user (such as by email with a secure link to the report).

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations to be performed in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles and the novel features disclosed herein.

What is claimed is:

1. A computer-implemented method for generating a credit profile, comprising:
obtaining a plurality of financial based interactions of a user;
generating one or more behavior trait indicators based on the plurality of financial based interactions; and
generating the credit profile of the user based on the one or more behavior trait indicators.

2. The method of claim 1, wherein the one or more behavior trait indicators includes one or more of:
a self-control indicator;
an ostrich bias indicator; or
a procrastination indicator.

3. The method of claim 2, wherein generating the self-control indicator includes:
determining a plurality of self-control metrics from the group consisting of:
a discretionary purchase metric of user purchases with reference to when a user receives money;
a calendar day based purchase metric of user purchases with reference to calendar days associated with merchant sales;
a reimbursement metric of user purchases;
a commitment metric of user goals achieved or planned;
a cash liquidity metric of the user;
a donation metric of user donations; and
a debt metric of the user; and
generating a score indicating a prediction as to potential future bankruptcy or future credit card debt of the user based on the plurality of self-control metrics.

4. The method of claim 3, wherein generating the score includes grouping the user with other similar users using fuzzy clustering of the plurality of self-control metrics, wherein the score is with reference to the group of similar users and the score indicates a level of financial self-control for purchases.

5. The method of claim 4, wherein generating the score also includes:
determining a significance of one or more of the self-control metrics to predict future bankruptcy or future credit card debt of the user to be less than a threshold; and
eliminating the one or more self-control metrics from being used for fuzzy clustering.

6. The method of claim 2, wherein:
the plurality of financial based interactions of the user includes user interaction metrics with a financial management tool; and
generating the ostrich bias indicator includes:
determining a negative event affecting user sentiment;
determining whether a change in the user interaction metrics occurs in response to determining the negative event affecting user sentiment; and
generating a score indicating a user avoidance of negative news.

7. The method of claim 6, wherein the negative event includes one or more of:
a reduction in one or more financial instrument values by more than a first threshold; or
a reduction in one or more user asset values by more than a second threshold.

8. The method of claim 7, wherein the user interaction metrics with the financial management tool includes a login pattern by the user to the financial management tool.

9. The method of claim 2, wherein:
the plurality of financial based interactions of the user includes:
credit card late fees paid by the user;
credit card debt of the user;
monthly income of the user; and
savings of the user; and
generating the procrastination indicator includes:
generating an ability to pay metric based on the savings of the user with reference to the credit card debt and the monthly income; and
generating a score indicating whether the user voluntarily procrastinates in paying credit card debt based on the ability to pay metric.

10. The method of claim 2, wherein the credit profile of the user is further based on one or more of liabilities of the user or assets of the user.

11. A system for generating a credit profile, comprising:
one or more processors; and
a memory storing instructions that, when executed by the one or more processors, causes the system to perform operations comprising:
obtaining a plurality of financial based interactions of a user;
generating one or more behavior trait indicators based on the plurality of financial based interactions; and
generating the credit profile of the user based on the one or more behavior trait indicators.

12. The system of claim 11, wherein the one or more behavior trait indicators includes one or more of:
a self-control indicator;
an ostrich bias indicator; or
a procrastination indicator.

13. The system of claim 12, wherein generating the self-control indicator includes:
determining a plurality of self-control metrics from the group consisting of:
a discretionary purchase metric of user purchases with reference to when a user receives money;
a calendar day based purchase metric of user purchases with reference to calendar days associated with merchant sales;
a reimbursement metric of user purchases;
a commitment metric of user goals achieved or planned;
a cash liquidity metric of the user;
a donation metric of user donations; and
a debt metric of the user; and
generating a score indicating a prediction as to potential future bankruptcy or future credit card debt of the user based on the plurality of self-control metrics.

14. The system of claim 13, wherein generating the score includes grouping the user with other similar users using fuzzy clustering of the plurality of self-control metrics, wherein the score is with reference to the group of similar users and the score indicates a level of financial self-control for purchases.

15. The system of claim 14, wherein generating the score also includes:
determining a significance of one or more of the self-control metrics to predict future bankruptcy or future credit card debt of the user to be less than a threshold; and
eliminating the one or more self-control metrics from being used for fuzzy clustering.

16. The system of claim 12, wherein:
the plurality of financial based interactions of the user includes user interaction metrics with a financial management tool; and
generating the ostrich bias indicator includes:
determining a negative event affecting user sentiment;
determining whether a change in the user interaction metrics occurs in response to determining the negative event affecting user sentiment; and
generating a score indicating a user avoidance of negative news.

17. The system of claim 16, wherein the negative event includes one or more of:
a reduction in one or more financial instrument values by more than a first threshold; or
a reduction in one or more user asset values by more than a second threshold.

18. The system of claim 17, wherein the user interaction metrics with the financial management tool includes a login pattern by the user to the financial management tool.

19. The system of claim 12, wherein:
the plurality of financial based interactions of the user includes:
credit card late fees paid by the user;
credit card debt of the user;
monthly income of the user; and
savings of the user; and
generating the procrastination indicator includes:
generating an ability to pay metric based on the savings of the user with reference to the credit card debt and the monthly income; and
generating a score indicating whether the user voluntarily procrastinates in paying credit card debt based on the ability to pay metric.

20. The system of claim 12, wherein the credit profile of the user is further based on one or more of liabilities of the user or assets of the user.
